(19) United States
(12) Patent Application Publication
(10) Pub. No.: US 2008/0285423 A1
(43) Pub. Date: Nov. 20, 2008

(54) OPTICAL PICKUP APPARATUS

(75) Inventor: Shinichi SAKO, Higashihiroshima-shi (JP)

Correspondence Address: MORRISON & FOERSTER LLP, 1650 TYSONS BOULEVARD, SUITE 400, MCLEAN, VA, 22102, US

(73) Assignee: Sharp Kabushiki Kaisha, Osaka-shi (JP)

(21) Appl. No.: 12/121,336

(22) Filed: May 15, 2008

(30) Foreign Application Priority Data
May 16, 2007 (JP) 2007-130659

(51) Int. Cl. G11B 7/135

(52) U.S. Cl. 369/112.23

(57) ABSTRACT

An optical pickup apparatus includes: an optical pickup actuator including an objective lens for converging an optical beam emitted from a light source to a surface of a recording medium, a lens holder for holding the objective lens, an elastic support member for elastically supporting the lens holder at its one end to be capable of driving the lens holder, and a base member for fixing and holding the other end of the elastic support member; a casing that supports the base member of the actuator; a flexible substrate for taking a signal from the optical beam; a substrate pressing member for restricting floating of the flexible substrate; and an actuator restricting holding part that is mounted integrally with the substrate pressing member and holds the base member while restricting operation of the base member to a predetermined operation.

### CROSS-REFERENCE TO RELATED APPLICATION

This application is related to Japanese patent application No. 2007-130659 filed on May 16, 2007 whose priority is claimed under 35 USC §119, the disclosure of which is incorporated by reference in its entirety.

### BACKGROUND OF THE INVENTION

1. Field of the Invention

The present invention relates to an optical pickup apparatus, and more particularly to an optical pickup apparatus adaptable to record/reproduce information with an optical disc used as a recording medium.

2. Description of the Related Art

A conventional technique will firstly be described with reference to FIGS. 3A to 4B. In FIGS. 3A to 4B, an optical pickup apparatus that uses an optical disc 11 as a recording medium includes focus direction driving means for controlling an optical beam 19, which is detected through an objective lens 1, to be guided to an optimum focal position on the optical disc 11, tracking direction driving means for following a specific track on the optical disc 11, and as the case may be, tilt direction driving means for tilting the objective lens 1 according to a tilt of the optical disc 11, in order to record information onto the optical disc 11 or reproduce the information recorded on the optical disc 11.

As the focus direction driving means, a drive mechanism is employed, which includes a focus coil 5 and a magnet 3, and drives a lens holder 2 holding the objective lens 1 in an optical axis direction and makes the lens holder 2 follow a focus of a beam spot on the optical disc 11.

As the tracking direction driving means, a drive mechanism is employed, which uses a tracking coil 6 and the magnet 3 for driving the lens holder 2 supporting the objective lens 1 in the direction orthogonal to the optical axis so as to cause the beam spot to follow a specific track on the optical disc 11.

Examples of the method of supporting the lens holder 2 on a base plate 7 includes a method in which, for example, the lens holder 2 is supported in a cantilevered manner by four elastic support members 4, i.e., an upper, a lower, a left and a right members parallel to one another. With this configuration, driving force generated by the focus coil 5, the tracking coil 6, and the magnet 3 can be transmitted in a focusing direction and a tracking direction due to the bending deformation of the elastic support members 4.

The tilt of the base plate 7, having placed thereon a support member 12 for fixing and supporting the other ends of the four elastic support members 4 that are arranged parallel to one another, is changed, so that posture adjustment is performed for making the tilt of the objective lens 1 optimum.

The operation of the base plate 7 is restricted through actuator restricting means 13, whereby posture adjustment is performed for stably making the tilt and height of the objective lens 1 optimum.

A substrate pressing member 10 for restricting floating of a flexible substrate 9, which takes a signal from the optical beam 19, is provided separately from the actuator restricting means 13.

In Japanese Unexamined Patent Publication No. 2004-241117, the flexible substrate and actuator restricting means are separately provided, so that the number of components is increased. Since the flexible substrate extends from the casing in parallel with the casing, the flexible substrate might be damaged due to a sliding movement.

As described above, the conventional configuration entails a problem that the number of components, weight, and cost are increased, since the actuator restricting means and the substrate pressing member are separately provided.

### SUMMARY OF THE INVENTION

An object of the present invention is to provide an optical pickup apparatus that can be reduced in number of components, weight, and cost.

The present invention provides an optical pickup apparatus comprising an optical pickup actuator including an objective lens for converging an optical beam emitted from a light source to a surface of a recording medium, a lens holder for holding the objective lens, an elastic support member for elastically supporting the lens holder at its one end to be capable of driving the lens holder, and a base member for fixing and holding the other end of the elastic support member; a casing that supports the base member of the optical pickup actuator; a flexible substrate for taking a signal from the optical beam; a substrate pressing member for restricting floating of the flexible substrate; and an actuator restricting holding part that is mounted integrally with the substrate pressing member and holds the base member while restricting the operation of the base member to a predetermined operation.

According to the optical pickup apparatus of the present invention, the actuator restricting holding part for holding the base member is provided integrally with the substrate pressing member for restricting floating of the flexible substrate. Therefore, the number of components, weight, and cost can be reduced.

The actuator restricting holding part is made, for example, by forming a thin plate into a corrugated shape or curved shape, whereby the actuator restricting holding part is less warped and has excellent rigidity.

It is preferable that, in the optical pickup apparatus according to the present invention, the flexible substrate projects to a side from the casing as tilted in the direction reverse to the front surface of the flexible substrate. With this configuration, a bending load of the flexible substrate can be reduced.

It is preferable that, in the optical pickup apparatus according to the present invention, the flexible substrate projects to a side from the casing as tilted in the opposite direction to the front surface of the flexible substrate. With this configuration, a bending load of the flexible substrate can be reduced.

It is preferable that, in the optical pickup apparatus according to the present invention, the flexible substrate projects to a side from the casing as tilted in the opposite direction to the front surface of the flexible substrate, and the leading end of the substrate pressing member is folded in the direction of the front surface of the flexible substrate. With this configuration, not only a bending load of the flexible substrate can be reduced, but also the flexible substrate can be prevented from being damaged.

It is preferable that, in the optical pickup apparatus according to the present invention, the substrate pressing member is made of a molding material, or is formed integrally with its protection cover. With this configuration, the number of components, weight, and cost can further be reduced.

### BRIEF DESCRIPTION OF THE DRAWINGS

FIGS. 1A and 1B show diagrams for describing a configuration of an optical pickup apparatus according to a first embodiment of the present invention, where FIG. 1A shows a plan view, and FIG. 1B shows a longitudinal cross-sectional view viewed from the front;

FIGS. 2A and 2B are enlarged diagrams showing main part for describing a configuration of the optical pickup apparatus shown in FIGS. 1A and 1B, where FIG. 2A is an enlarged plan view showing main part, and FIG. 2B is a transverse cross-sectional view viewed from a side;

FIGS. 3A and 3B show diagrams for describing a configuration of a conventional optical pickup apparatus, where FIG. 3A shows a plan view, and FIG. 3B shows a longitudinal cross-sectional view viewed from the front;

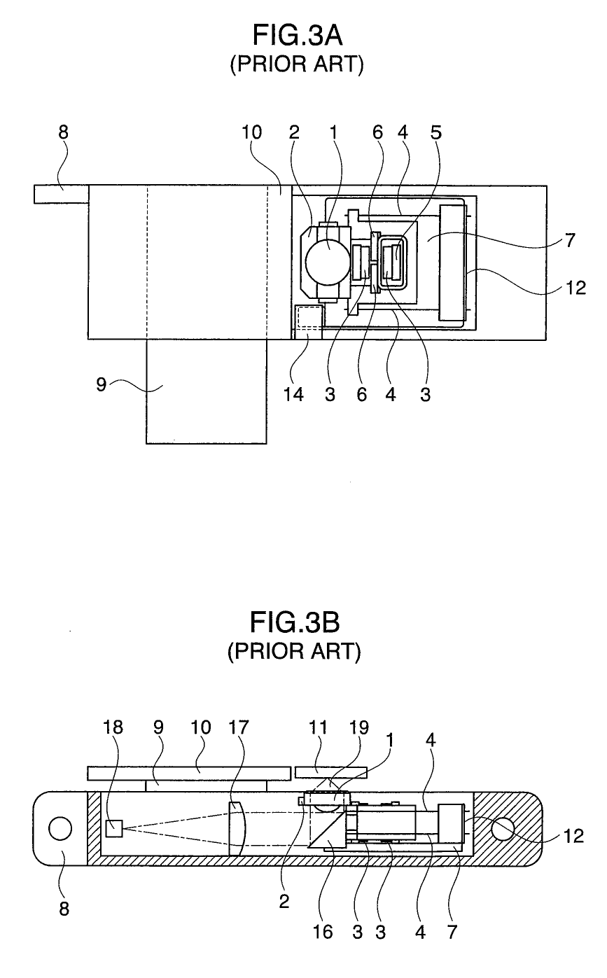

FIGS. 4A, 4B, and 4C show diagrams for describing a configuration of the optical pickup apparatus shown in FIGS. 3A and 3B in which a flexible substrate, which is one constituent of the optical pickup apparatus, is drawn, where FIG. 4A shows a plan view, FIG. 4B shows a longitudinal cross-sectional view viewed from the front, and FIG. 4C shows a side view;

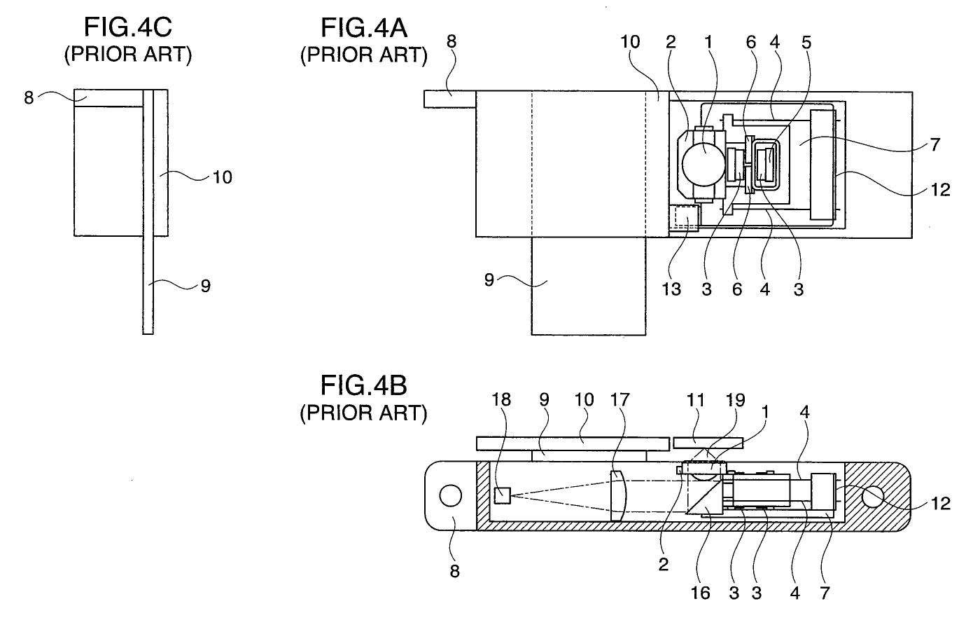

FIGS. 5A, 5B, and 5C show diagrams for describing a configuration of an optical pickup apparatus according to a second embodiment of the present invention in which a flexible substrate, which is one constituent of the optical pickup apparatus, is drawn, where FIG. 5A shows a plan view, FIG. 5B shows a longitudinal cross-sectional view viewed from the front, and FIG. 5C shows a side view; and

FIG. 6 shows an enlarged perspective view of an actuator restricting holding part in the optical pickup apparatus according to the first and second embodiments of the present invention.

### DETAILED DESCRIPTION OF THE INVENTION

Two embodiments according to the present invention will be described in detail below with reference to the drawings. It should be noted that the present invention is not limited by these embodiments.

### First Embodiment

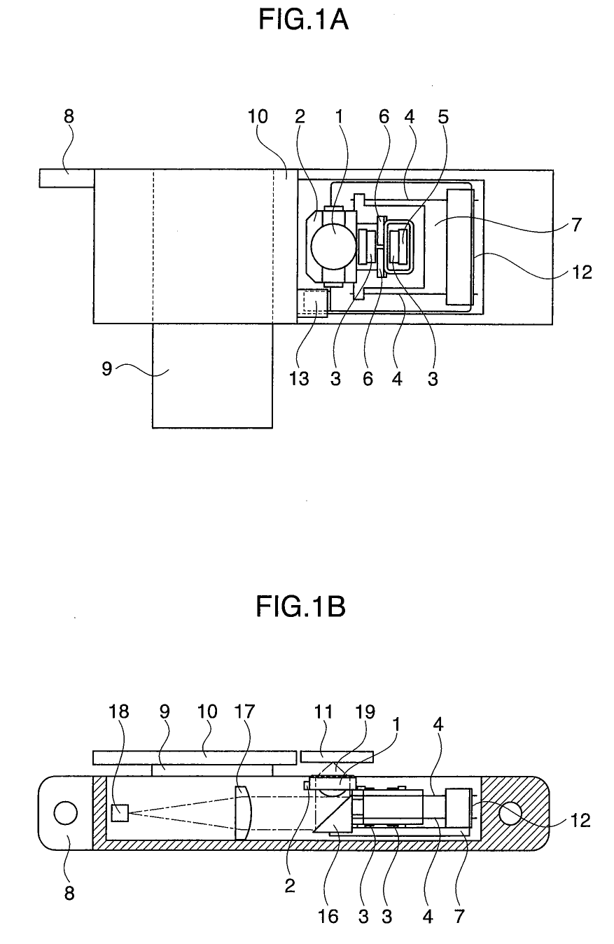

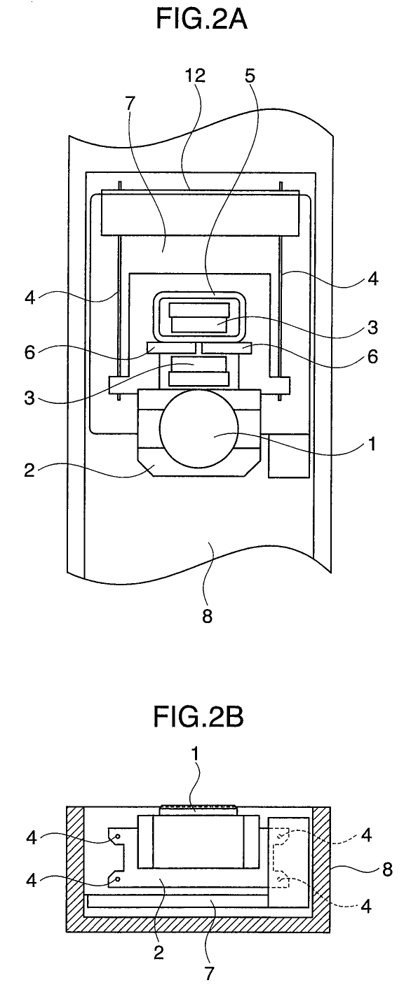

A first embodiment 1 of the present invention will be described with reference to FIGS. 1A to 2B. FIGS. 1A and 1B are diagrams for describing a configuration of an optical pickup apparatus according to the first embodiment of the present invention, where FIG. 1A is a plan view, and FIG. 1B is a longitudinal cross-sectional view viewed from the front. FIGS. 2A and 2B are enlarged diagrams showing main part (an actuator portion) for describing the configuration of the optical pickup apparatus shown in FIGS. 1A and 1B. Specifically, FIG. 2A is an enlarged plan view showing main part, and FIG. 2B is a transverse cross-sectional view viewed from a side.

As shown in FIGS. 1A to 2B, an objective lens 1 is mounted to an end portion of a lens holder 2 in an actuator of the optical pickup apparatus. The lens holder 2 is provided with a focus coil 5 for driving an optical beam 19, detected from the objective lens 1, in a focusing direction, and a tracking coil 6 for driving the optical beam 19 in a tracking direction. A magnet 3, serving as magnetic circuit means, is arranged on a base plate 7 (base member) so as to sandwich the focus coil 5 and the tracking coil 6.

The lens holder 2 is mounted to four elastic support members 4 that are mounted to the base plate 7 to be supported by the base plate 7 and are made of, for example, a thin metallic plate member, a wire, or the like.

The lens holder 2 is mounted to the base plate 7 in the manner described below. Specifically, the lens holder 2 is supported by one ends of the wire-like four elastic support members 4, i.e., upper, lower, left, and right members, arranged parallel to one another. The other ends of the four elastic support members 4 are fixed to the base plate 7 through a support member 12 and are supported through a damping material, so that they are movable with respect to the base plate 7.

Driving force produced by the focus coil 5, the tracking coil 6, and the magnet 3 can be transmitted in the focusing direction and the tracking direction due to the bending deformation of the elastic support members 4.

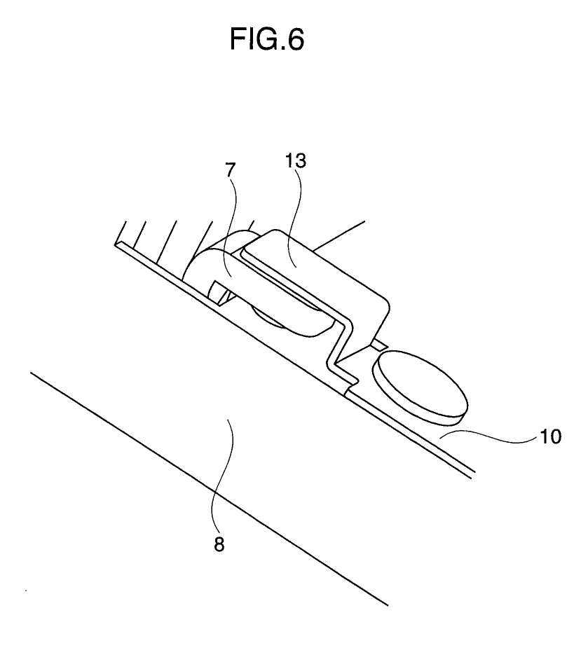

As shown in FIG. 6, the operation of the base plate 7 is restricted to a predetermined operation by an actuator restricting holding part 13. With this configuration, posture adjustment can be performed, which stably makes the tilt or the height of the objective lens 1 optimum.

The actuator restricting holding part 13 is made by forming, for example, a thin plate into a corrugated shape or curved shape, whereby the actuator restricting holding part is less warped and has excellent rigidity. As a result, the movable range of the actuator can surely be restricted.

Further, a substrate pressing member 10 for restricting floating of the flexible substrate 9, which takes a signal from the optical beam 19, is provided integrally with the actuator restricting holding part 13. Accordingly, the number of components, weight, and cost can be reduced.

### Second Embodiment

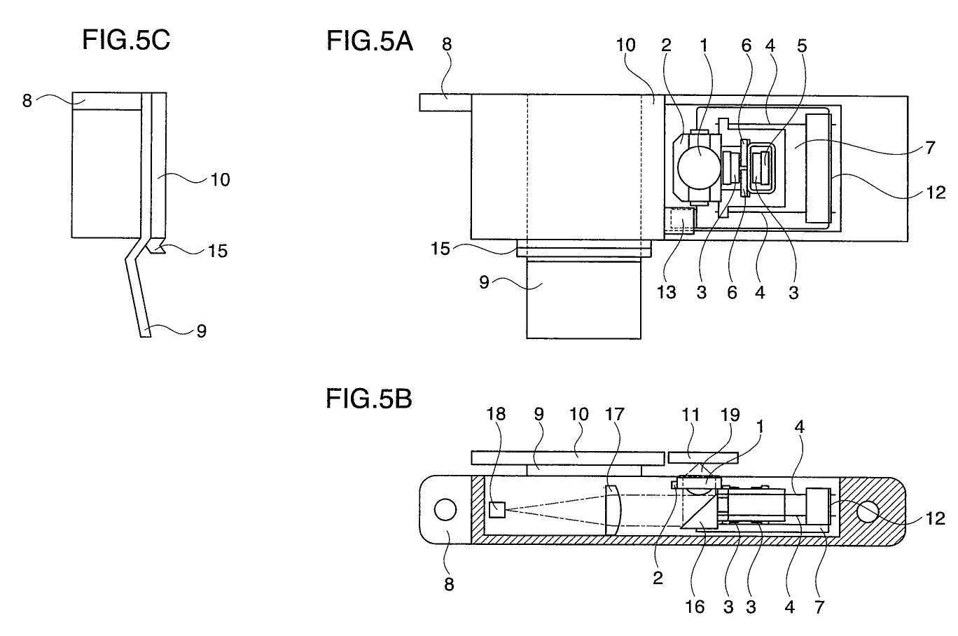

A second embodiment of the present invention will be described with reference to FIGS. 5A to 5C. FIGS. 5A, 5B, and 5C are diagrams for describing a configuration of an optical pickup apparatus according to the second embodiment of the present invention, where FIG. 5A is a plan view, FIG. 5B is a longitudinal cross-sectional view viewed from the front, and FIG. 5C is a side view.

As shown in FIGS. 5A to 5C, an objective lens 1 is mounted to an end portion of a lens holder 2 in an actuator of the optical pickup apparatus. The lens holder 2 is provided with a focus coil 5 for driving an optical beam, detected from the objective lens 1, in a focusing direction, and a tracking coil 6 for driving the optical beam in a tracking direction. A magnet 3, serving as magnetic circuit means, is arranged on a base plate 7 so as to sandwich the focus coil 5 and the tracking coil 6.

The lens holder 2 is mounted to four elastic support members 4 that are mounted to the base plate 7 to be supported by the base plate 7 and are made of, for example, a thin metallic plate member, a wire, or the like.

The lens holder 2 is mounted to the base plate 7 in the manner described below. Specifically, the lens holder 2 is supported by one ends of the wire-like four elastic support members 4, i.e., upper, lower, left, and right members, arranged parallel to one another. The other ends of the four elastic support members 4 are fixed to the base plate 7 through a support member 12 and are supported through a damping material, so that they are movable with respect to the base plate 7.

Driving force produced by the focus coil 5, the tracking coil 6, and the magnet 3 can be transmitted in the focusing direction and the tracking direction due to the bending deformation of the elastic support members 4.

As shown in FIG. 6, the operation of the base plate 7 is restricted by an actuator restricting holding part 13. With this configuration, posture adjustment can be performed, which stably makes the tilt or the height of the objective lens 1 optimum.

The actuator restricting holding part is made by forming, for example, a thin plate into a corrugated shape or curved shape, whereby the actuator restricting holding part is less warped and has excellent rigidity. As a result, the movable range of the actuator can surely be restricted.

Further, a substrate pressing member 10 for restricting floating of the flexible substrate 9, which takes a signal from an optical beam 19, is provided integrally with the actuator restricting holding part 13. Accordingly, the number of components, weight, and cost can be reduced.

As shown in FIGS. 5A and 5C, the flexible substrate 9 projects to a side from a casing 8 as tilted in the opposite direction to the front surface thereof. Further, the leading end 15 of the substrate pressing member 10 is folded in the direction of the front surface of the flexible substrate 9. As a result, a bending load of the flexible substrate 9 can be reduced, and further, the flexible substrate 9 can be prevented from being damaged.

What is claimed is:

1. An optical pickup apparatus comprising:
an optical pickup actuator including an objective lens for converging an optical beam emitted from a light source to a surface of a recording medium, a lens holder for holding the objective lens, an elastic support member for elastically supporting the lens holder at its one end to be capable of driving the lens holder, and a base member for fixing and holding the other end of the elastic support member;
a casing that supports the base member of the actuator;
a flexible substrate for taking a signal from the optical beam;
a substrate pressing member for restricting floating of the flexible substrate; and
an actuator restricting holding part that is mounted integrally with the substrate pressing member and holds the base member while restricting operation of the base member to a predetermined operation.

2. The optical pickup apparatus according to claim 1, wherein
the actuator restricting holding part has one of a corrugated shape and a curved shape.

3. The optical pickup apparatus according to claim 1, wherein
the flexible substrate projects to a side from the casing as tilted in an opposite direction to a front surface thereof.

4. The optical pickup apparatus according to claim 1, wherein
the substrate pressing member has a leading end folded in a direction of a front surface of the flexible substrate.

5. The optical pickup apparatus according to claim 1, wherein
the substrate pressing member is made of a molding material.

6. The optical pickup apparatus according to claim 1, wherein
the substrate pressing member is provided integrally with its protection cover.
